(19) United States
(12) Patent Application Publication
(10) Pub. No.: US 2006/0107283 A1
(43) Pub. Date: May 18, 2006

(54) Method and system for suppplying digital files to a customer

(75) Inventor: Scott Murphy, Melbourne (AU)

Correspondence Address: MORRISON & FOERSTER LLP, 1650 TYSONS BOULEVARD, SUITE 300, MCLEAN, VA, 22102, US

(73) Assignee: DNET MEDIA PTY LIMITED, Windsor (AU)

(21) Appl. No.: 10/522,146

(22) PCT Filed: Jul. 14, 2003
(86) PCT No.: PCT/AU03/00909

§ 371 Date: Sep. 26, 2005

(30) Foreign Application Priority Data
Jul. 24, 2002 (AU) 2002950345

(51) Int. Cl. H04N 7/16; H04N 7/173; H04N 5/445; H04N 7/167

(52) U.S. Cl. 725/25; 725/86; 725/87; 725/39; 725/31

(57) ABSTRACT

A method for supplying digital files to a customer via a data communications network (22), wherein a recordable medium (21, 27) is provided to the customer, the method including the steps of (a) registering details of the customer and the recordable medium (21, 27) in a data bank (7), (b) receiving a customer request to supply one or more digital files, (c) authenticating the recordable medium (21, 27) and the identity of the customer, and (d) if authentication is successful, supplying the requested one or more digital files from the data bank (7) to a client terminal (20) via the data communications network (22) for recordal on the recordable medium (21, 27).

The present invention relates generally to the supply of digital files to a customer from a content owner, and in particular to the supply of digital files via a telecommunications network, such as the Internet. It will be convenient to describe the invention in relation to the supply of musical audio files to a customer via the Internet, however it will be appreciated that the invention is suitable for use in the supply of all audio, video and/or data files.

Record companies or artists traditionally sell their product to consumers by providing digital music files to manufacturers of compact disc. The manufacturers record the music files on the compact disc and distribute the recorded compact discs through distributors to retailers. Consumers then purchase the record compact discs from the retailers.

Whilst this method of purchasing music is generally accepted by consumers, it nevertheless requires the consumer to purchase music files in the preselected group recorded on a particular compact disc. Selection of individual music files is not available to the consumer by this method.

A less frequently used method of purchasing music files is provided by some record companies that maintain a database of music files accessible via the Internet from a record company server. Consumers are able to access the record company server from a personal computer connected to the Internet, and then download selected music files. The ability to access the music files is dependent upon the provision by the consumer of appropriate credit card details, and authorisation by a financial institution of the purchase of the music files by the consumer. The downloaded music file may be then stored on the hard drive of the personal computer, and played back to the consumer by sound reproduction software and a speaker system connected to the personal computer. Alternatively, the music files may be recorded on a recordable compact disc. The compact disc can then be used in a conventional compact disc player.

Whilst this method of obtaining music files provides greater flexibility to the customer, it is relatively infrequently used. Consumers must firstly purchase one or more blank recordable compact discs. The consumer must then be familiar with locating the websites of various record companies providing downloadable music files. Moreover, this activity is dissociated from the regular music purchasing activities of a consumer.

It would be desirable to provide a method of supplying music and other digital files to customers in a simple, efficient manner.

It would also be desirable to provide a method of supplying music and other digital files to a customer that ameliorated or overcame one or more problems of existing music file supply methods and systems.

With this in mind, one aspect of the present invention provides:

a method for supplying digital files to a customer via a data communications network, wherein a recordable medium is provided to the customer, the method including the steps of:

(a) registering details of the customer and the recordable medium in a data bank,

(b) receiving a customer request to supply one or more digital files,

(c) authenticating the recordable medium and the identity of the customer, and

(d) if authentication is successful, supplying the requested one or more digital files from the data bank to a client terminal via the data communications network for recordal on the recordable medium.

The recordable medium may be a recordable digital video disc (DVD).

The recordable DVD may be connectable to the client terminal by a recordable DVD drive.

The digital files may be music files or other video, audio or data content.

The recordable medium supplied to the customer may include one or more pre-recorded digital files.

The recordable medium may include a recordable medium identifier.

The method may include:

registering the recordable medium identifier and the customer details in the data bank in step (a), and

detecting the recordable medium identifier from the recordable medium in step (c).

The customer details may include a customer name and password.

Step (c) may include:

receiving customer entered validation data, and

comparing the validation data to the customer name and password stored in the data bank.

The data bank may be maintained by a predetermined content supplier.

the method may include:

receiving the customer request in step (b) at an intermediary server;

identifying the predetermined content supplier, and

directing the customer request to the data bank of that predetermined content supplier.

The recordable medium may include a content supplier identifier.

The method may include:

identifying the predetermined content supplier by detecting the content supplier identifier at the intermediary server.

The method may further include:

issuing the manufacturer and retailer with unique identifying codes.

The method may further include:

processing customer payment for the one or more digital files.

The customer payment may be processed when the recordable medium is provided to the customer.

The customer payment may relate to the pre-recorded digital files only.

The customer payment may alternatively relate to the pre-recorded digital files and one or more digital files supplied in step (d).

The customer payment may be processed when a customer request is received in step (b).

The method may further include:

providing the customer with notification of one or more digital files able to be supplied from the data bank.

The notification may be realised by the transmission of an SMS message, email or other electronic communication.

Another aspect of the invention relates to a system for supplying digital files to a customer via a data communications network, including a content owner server and data bank, retail server and local client including computer software to enable the steps of the above described method to be carried out.

Yet another aspect of the invention provides a content server for use with a system for supplying digital files to a customer via a data communications network, the content server including a processing unit and associated memory device for storing computer software for causing the content server to carry out a method as described above.

A further aspect of the invention provides computer software for use with a content server forming part of the system for supplying digital files to a customer via a data communications network, the content server including a processing unit and associated memory device for storing the computer software, wherein the computer software acts to cause the content server to carry out a method as described above.

For assistance in arriving at an understanding of the invention, one example of the method and system for supplying digital files to a customer via a data communications network is illustrated in the attached drawings. The particularity is not to be understood as superseding the generality of the invention.

In the drawings:

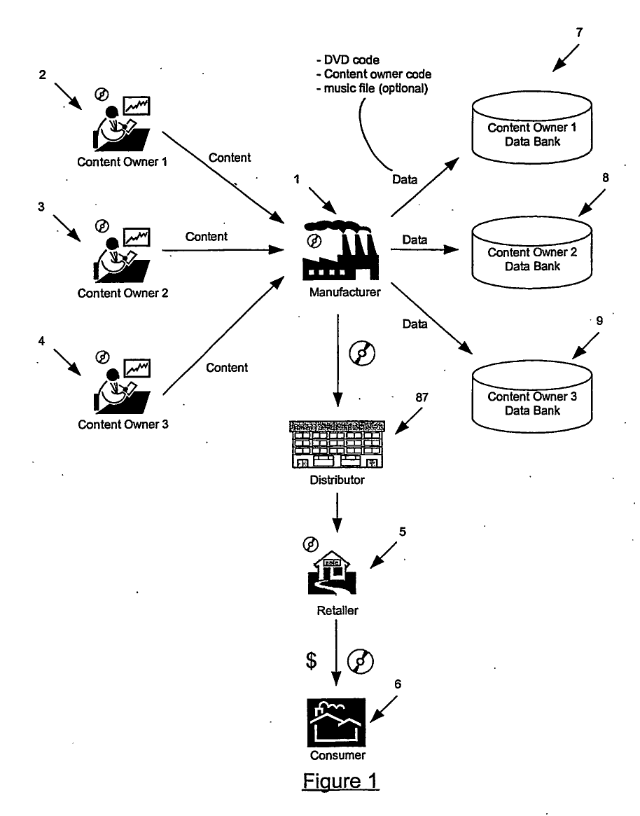

FIG. 1 is a schematic diagram illustrating the production and supply to a customer of a DVD as part of one embodiment of a method for supplying digital files to a customer according to the present invention.

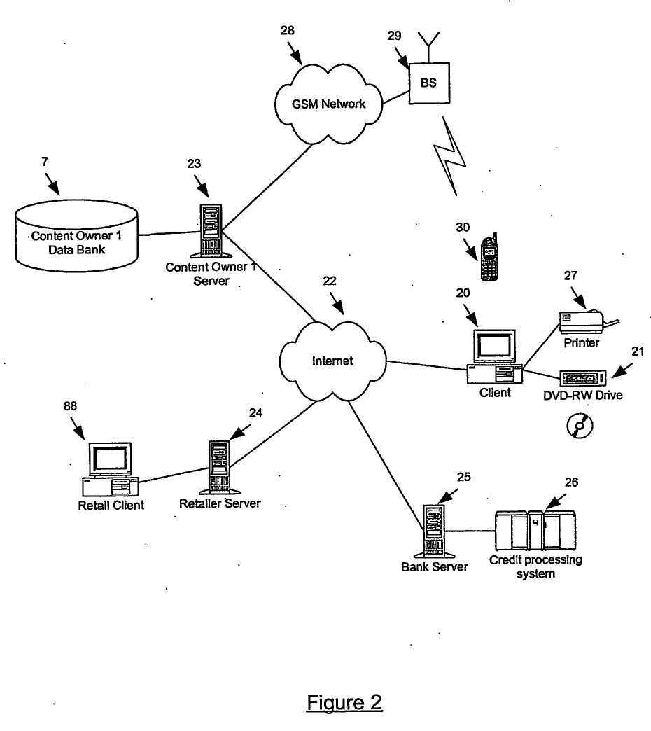

FIG. 2 is a schematic diagram of one embodiment of a system for supplying digital files to a customer via a data communications network in conjunction with the method of FIG. 1; and

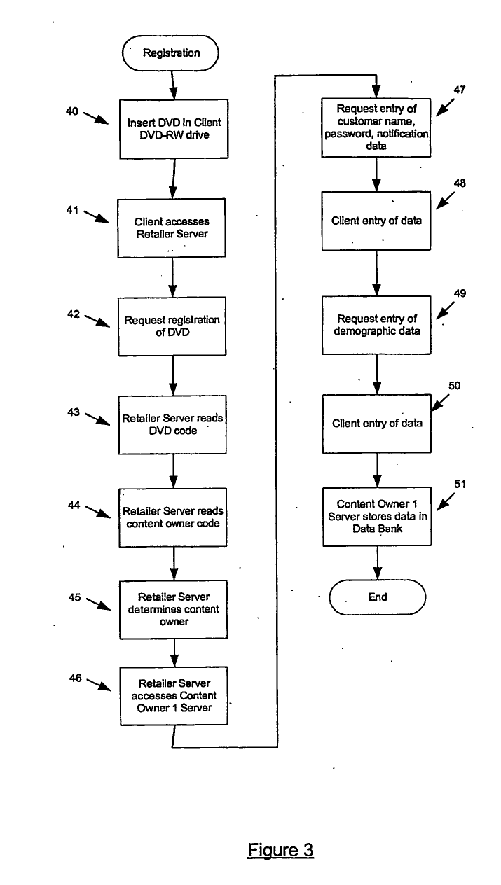

FIGS. 3 to 5 are flow charts showing the functional steps performed by the system of FIG. 2.

Referring now to FIG. 1, there is shown generally a manufacturer 1 of DVD, record companies 2 to 4, a retailer 5, distributor 87, and a consumer 6. The manufacturer 1 manufactures DVD or other recordable media on behalf of the content owners 2 to 4. The manufacturer 1 embeds code representative of a unique DVD identifier on each DVD. Code representative of a content owner identifier is also embedded on the DVD. Optionally, music files or other content is provided from each of the content owners and also included on each manufactured disc. Data representative of the DVD identifier, content owner identifier, manufacturer identifier and any music files encoded on the DVD are recorded in data banks 7 to 9 maintained respectively by the content owners 2 to 4.

Each DVD may also be pressed with an existing DVD copy protection system, ensure that the DVD identifier, content owner identifier and music file encoded on the, DVD at this stage cannot be copied in any way at a later time.

The manufacturer then provides the pre-pressed DVD to the retailer 5 via a distributor 87 for resale, either through traditional outlets and/or via a retailer website, to the consumer 6. Alternatively, websites may be maintained by the manufacturer and/or the content owners 2 to 4 to facilitate the direct purchase of the DVD by the consumer 6. The consumer 6 has thus purchased the DVD from the retailer 5 in a conventional manner, and if that DVD has been encoded with one or more pre-recorded music files, is able to insert that DVD into a DVD player and listen to the pre-recorded music files.

If the consumer wishes to include additional music files on the DVD, the consumer 6 does so by accessing a personal computer and associated DVD-RW drive connected to the Internet. Referring now to FIG. 2, an exemplary personal computer 20 and associated DVD-RW drive 21 are illustrated. The personal computer 20 is connected to the Internet 22 or other data communications network. Servers maintained by each of the content owners 2 to 4 are also connected to the Internet 22. An exemplary content owner server 23, providing access to the content owner data bank 7, is illustrated in this Figure. FIG. 2 also shows a retail server 24 maintained by the retailer 5 and a bank server 25 and associated credit processing system 26 accessible from the Internet 22 to facilitate the processing of customer payment for music files. A printer 27 is also shown as being connected to the personal computer 20.

In addition, the content owner server 23 is connected to a GSM network 28 and bas station 29 for providing notification, via an SMS message or other electronic communication means, to a mobile telephone 30 associated with the customer 6.

As seen in FIG. 3, the DVD purchased by the consumer 6 is inserted at step 40 in the DVD-RW drive 21 associated with the personal computer 20. The personal computer 20 may be located at the home or the work place of the customer, or alternatively may be provided at a retail outlet of the retailer 5.

At step 41, once the customer has established a connection to the Internet 22, conventional web browsing software is used to establish a session with a website maintained by the retailer 5 on the retailer server 24. It will be appreciated that in other embodiments of the invention, the website accessed by the customer at this step may be maintained by one of the content owners 2 to 4, the manufacturer 1 or another party.

By clicking on the relevant icons provided on that website, the consumer then proceeds to register as the owner of the DVD. At step 42, a request for registration of the DVD is transmitted from the personal computer 20 to the retailer server 24. Upon receipt of that request, the retailer server acts, at step 43, to read the unique DVD identifier encoded on the DVD.

At step 44, the retailer server acts to read the content owner's identifier encoded on the DVD. The retailer server 24 maintains data tables to enable a determination to then be made at step 45 of the identity of the content owner on behalf of which the manufacturer 1 has manufactured the DVD. The data tables include the IP address of the content owner server 23 maintained by that content owner. At step 46, the retailer server 24 directs the customer request from the personal computer 20 to the content owner server 23. A connection session is then effectively established between the personal computer 20 and the content owner server 23 via the intermediary retailer server 24. The content owner server 23 then requests that the customer provide registration details. Initially, at step 47, the customer is requested to provide their name and select an associated password. The customer can optionally provide notification data indicative of a medium, such as email, SMS message or other electronic communication means, by which the customer prefers to be advised of release dates of existing or future digital music files which will be available for downloading and recordal on their particular DVD.

At step 48, the customer enters the data via the personal computer 20. The information provided by the consumer is then stored in the content owner data bank 7 in a record including the unique DVD identifier and content owner identifier.

At step 49, the consumer may be requested to provide demographic data, such as age, address, musical preferences, media preferences, etc, for use by the content owner 2. The consumer may also be asked to give permission to the content owner 2, and optionally the retailer 5, to send the consumer information relating to other products or services offered by the content owner 2 and/or the retailer 5. The demographic data may be entered at step 50. At step 51, the data entered by the consumer is stored in the content owner data bank 7.

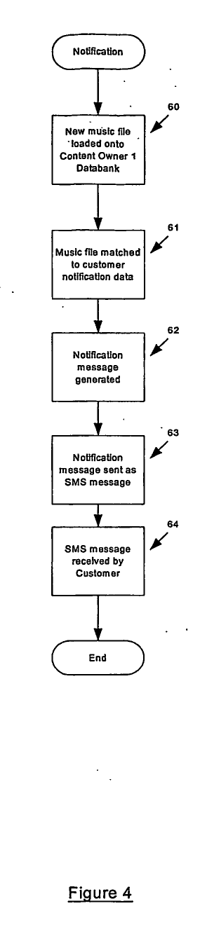

Once new music files are loaded onto the content owner data bank 7 at step 60 in FIG. 4, the characteristics of that music file are then matched to the stored customer notification data at step 61. For those customers having requested notification of that music file, a notification message is generated at step 62 by the content owner server 23. At step 63, the notification message is transmitted as an email via the Internet and/or transformed into an SMS message and transmitted over the GSM network 28 to the base station 29. It will be appreciated that in alternative embodiments of the invention, notification may occur by way of email message or other form of electronic communication. The SMS message is then transmitted from the base station 29 and received, at steps 64 by the mobile telephone 30 associated with the customer. The customer is then alerted to the presence of the music file on the content owner data bank 7.

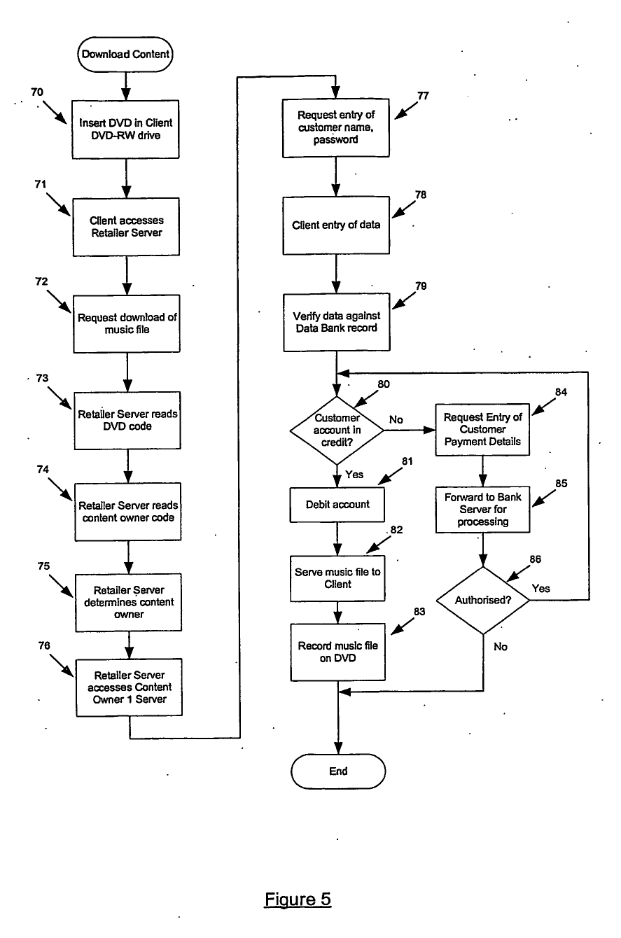

In order to download music files maintained on the content owner data bank 7, the customer again inserts the DVD purchased from the retailer 5 into the DVD-RW drive 21, at step 70 in FIG. 5. By using the conventional web browsing software loaded on the personal computer 20, the consumer establishes a connection with the retail server 24 at step 71. By clicking on appropriate icons on the website maintained by the retailer 5, a customer request to download one or more music files is generated at step 72. Upon receipt of this customer request, the retailer server 24, at step 73, reads the unique DVD identifier stored on the DVD. At step 74, the retailer server 24 then reads the content owner identifier encoded on the DVD. From the data tables maintained by the retailer server 24, a determination is made of the content owner on behalf of the manufacturer 1 manufactured the DVD in question.

At step 76, the retailer server forwards the customer request to the relevant content owner server. At step 77, the content owner server 23 requests entry of the customer's name and password. At step 78, the customer enters that data via the personal computer 20. At step 79, the entered customer name and password is being compared to the corresponding customer record maintained in the content owner data bank 7, in order to authenticate the customer and DVD identity.

Once the identity of the customer and the customer's ownership of the DVD has been verified, the customer is able to download music files stored on the content owner data bank 7. At step 80, the content owner server 23 establishes whether at the time of purchase of the DVD from the retailer 5, the consumer had paid for only the pre-recorded music file initially provided with the DVD, or had paid for the right to be able to download additional music files at a later time. If the customer had paid for the right to download additional music files at the time of purchase, the content owner server 23 determines at step 80 that the customer account is in credit. An amount corresponding to the number of music files selected by the customer is then debited from the customer's account at step 81. A customer may also purchase the right to be able to download additional music files via the Internet at any time after the purchase of the DVD.

At step 82, the selected music files are then served from the content owner server 23 to the customer's personal computer 20. At step 83, the personal computer 20 acts to record the digital music files on the DVD in the DVD-RW drive 21.

If the customer had paid for only the pre-recorded music files provided with the DVD at the time of purchase, or had used funds in his or her account by having previously downloaded one or more additional music files, the customer account is determined at step 80 as being in debit. If this is the case, the content owner server 23 requests, at step 84, that the customer provide details of his or her credit card. At step 85, details of the customer's credit card are forwarded to the bank server 25 for processing by the credit processing system 26. If an authorisation message is received from the bank server 25, the customer is able to download a requested music file.

Upon receipt of an authorisation message from the bank server 25 by the content owner server 23, at step 86, the customer is able to download the requested music files from the content owner data bank 7. If at step 86 authorisation is not provided, downloading of music files is prevented.

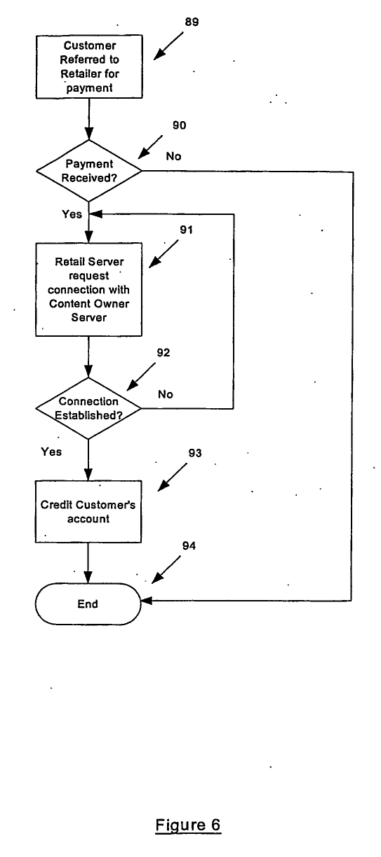

As shown in FIG. 6, at step 89, the customer may also be referred to the retailer 5 for payment. Upon receiving payment, at step 90, the retailer 5 requests the retail server 24 to establish a connection with the content owner server 23, shown in step 91. Once a connection is established, at step 92, between the retail server 24 and the content owner server 23, the retail server 24 requests the content owner server 23 to update the content owner data bank 23 at step 93 with the customer's payment. If a connection is not established at step 92, the retail server again requests a connection with the content owner server, step 91. When the customer's account is in credit, the customer may attempt to download files again, at step 7 in FIG. 5.

Prior to downloading the music file, the registered customer can elect to preview the music file before deciding whether or not to purchase and download the music file for recordal on the DVD. If the consumer elects to preview a music file, a selected portion of that music file may be streamed to the personal computer 20 so that the music file may be heard but not downloaded. A limitation may be placed on the number of times each music file may be streamed.

Customers may typically repeat the purchasing and downloading of music tracks as many times as the content owner in question issues new digital music files for a particular DVD.

Customers may also purchase DVD jukebox software from websites maintained by selected retailers. Some software, once installed on the hard drive of the personal computer 20, typically catalogues all information related to the DVD music files owned by that consumer, as well as additional data such as artists discographies, artists photos, artists biographies, etc. The principle function of the jukebox software is to enable the consumer to play the digital music files recorded on the DVD in order on the computer. With each download of a digital music file from the content owner server 23 may come updated information pertaining to that recording, as well as additional artists related information.

Along with the download of the digital music files, a registered customer may also elect to download to the hard drive a digital file which is a colour art document to be printed on the printer 27 for use as a colour cover (known in the industry as a “slick”) for the DVD. The slick may contain details of the new and existing music files downloaded by the customer and recorded on the DVD.

Each registered customer of a DVD may log onto the content owner server 23 at any time, either directly or via the retailer server 24, in order to update their profile and/or advise the content owner of the loss or theft of their DVD. The customer record in the content owner data bank 7 may thereafter be amended so as to prevent the download of music files.

In the above described example, a consumer pays for the initial DVD purchase (the DVD may or may not include one or more digital music files at the time of purchase), and then pays for any additional music file purchases. In other embodiments of the invention, however, the consumer may pay at the time of purchase of the DVD for one or more future music file downloads.

The above described example requires the entry of credit card information by a customer in order to purchase additional music file downloads, however in an alternative embodiments other payment systems may be used, such as existing bank payment transfer systems, payment at a retailer or cheque processing systems.

It will also be appreciated that the content owner server 23, retailer server 24, bank server 25 and personal computer 20 each include a processing unit and associated memory device for storing computer software to cause execution of the above described functionality.

In a further variant of the above described embodiment, music or other content which is initially provided with the purchased DVD and/or subsequently purchased and downloaded, may also be stored on a hard drive or other data storage device associated with the personal computer 20. Player software may be provided for use by the personal computer 20 to enable a consumer to play music or other content at the personal computer 20. In cases where the music or other content is stored on the data storage device associated with the personal computer 20, the consumer need not therefore have the content varying DVD inserted into the DVD drive. In this case, a consumer will be provided with two versions of content, namely a first version on the purchased DVD which is accessible via the DVD drive and any DVD player, and a second version stored on a data storage device associated with the personal computer 20 which is accessible only via that personal computer.

A DVD initially purchased by a consumer may contain tracks of either music content or music video content. After a consumer has initially been “signed up” as previously described, the consumer's personal computer 20 will be instructed to download the music content and/or music video content tracks in addition to the player software from the purchased DVD. The player software will be used to play the content on the personal computer 20 plus any relevant content related to the music content or music video content provided with that content. For example, artist's photos, cover art, audio/video interviews, biography, discography, or other supplemental content may be available together with the music content and/or music video content.

Upon each further download of music content and/or music video content for that particular DVD, an updated internal slick file, namely the external or cover slick that is provided with an initial DVD purchase but updated to include additional content subsequently downloaded and stored on the DVD, may be downloaded by the consumer so that a new external slick can be printed at home, cut to size and inserted into a DVD case or cover. Moreover, updated related content may be downloaded and stored on both the purchased DVD and the consumer's personal computer.

Finally, it is to be understood that various modifications and/or additions may be made to the method and system for supplying digital files to a customer without departing from the spirit or ambit of the present invention.

1. A method for supplying digital files to the customer via a data communications network, comprising
(a) providing a recordable medium to a customer,
(b) registering details of the customer and the recordable medium in a data bank,
(c) receiving a customer request to supply one or more digital files,
(d) authenticating the recordable medium and the identity of the customer, and
(e) if authentication is successful, supplying the requested one or more digital files from the data bank to a client terminal via the data communications network for recordal on the recordable medium.

2. A method according to claim 1, wherein the recordable medium is a recordable DVD.

3. A method according to claim 2, wherein the recordable DVD is connected to the client terminal by a recordable DVD drive.

4. A method according to claim 1, wherein the digital files are music files or other video, audio or data content.

5. A method according to claim 1, wherein the recordable medium supplied to the customer includes one or more pre-recorded digital files.

6. A method according to claim 1, wherein the recordable medium includes a recordable medium identifier.

7. A method according to claim 6, further comprising:
registering the recordable medium identifier and the customer details in the data bank in step (b), and
detecting the recordable medium identifier from the recordable medium in step (d).

8. A method according to claim 1, wherein the customer details include a customer name and password.

9. A method according to claim 1, wherein step (d) includes:
receiving customer entered validation data, and
comparing the validation data to the customer name and password stored in the data bank.

10. A method according to any one of the preceding claims claim 1, wherein the data bank is maintained by a predetermined content supplier.

11. A method according to claim 10, further comprising:
receiving the customer request in step (c) at an intermediary server;
identifying the predetermined content supplier, and
directing the customer request to the data bank of that predetermined content supplier.

12. A method according to claim 1, wherein the recordable medium includes a content supplier identifier.

13. A method according to claim 10, comprising:
identifying the predetermined content supplier by detecting the content supplier identifier at the intermediary server.

14. A method according to claim 1, further comprising:
issuing the manufacturer and retailer with unique identifying codes.

15. A method according to claim 1, further comprising:
processing customer payment for the one or more digital files.

16. A method according to claim 15, wherein the customer payment is processed when the recordable medium is provided to the customer.

17. A method according to claim 15, wherein the customer payment relates to the pre-recorded digital files only.

18. A method according to claim 15, wherein the customer payment relates to the pre-recorded digital files and one or more digital files supplied in step (e).

19. A method according to claim 15, wherein the customer payment processed when a customer request is received in step (c).

20. A method according to claim 1, further comprising:
providing the customer with notification of one or more digital files able to be supplied from the data bank.

21-22. (canceled)

23. Computer software stored on a readable medium for use with a content server forming part of the system for supplying digital files to a customer via a data communications network, the content server including a processing unit and associated memory device for storing the computer software, wherein the computer software acts to cause the content server to carry out a method according to claim 1.
